(19) United States
(12) Patent Application Publication
(10) Pub. No.: US 2010/0194529 A1
(43) Pub. Date: Aug. 5, 2010

(54) MANAGEMENT SYSTEM FOR CHARGING PLUG-IN VEHICLE

(75) Inventor: Tomokazu Yamamoto, Obu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/699,198

(22) Filed: Feb. 3, 2010

(30) Foreign Application Priority Data
Feb. 3, 2009 (JP) 2009-22683

(51) Int. Cl. G06F 7/04; G01C 21/00

(52) U.S. Cl. 340/5.65; 340/5.2; 701/207

(57) ABSTRACT

A plug-in vehicle has a door lock system which uses an electronic certification key. The electronic certification key stores a certification code and has a wireless communication device to transmit the code. A management system for charging the plug-in vehicle has a wireless communication device which can receive the certification code from the key, and a key verification module which verifies whether a proper key exists at the charging station or not. If a proper key is detected, the system permits charging the plug-in vehicle from a power outlet. On the other hand, if a proper key is not detected, the system denies and prohibits charging the plug-in vehicle from the power outlet.

### CROSS REFERENCE TO RELATED APPLICATION

This application is based on Japanese Patent Application No. 2009-22683 filed on Feb. 3, 2009, the contents of which are incorporated herein by reference in its entirety.

### FIELD OF THE INVENTION

The present invention relates to a management system for charging a plug-in vehicle, which enables the plug-in vehicle to be charged at a station from an external power source, such as a power outlet supplied with electricity from a commercial power supplier.

### BACKGROUND OF THE INVENTION

In recent years, developments of the plug-in vehicles and a system for charging, i.e., recharging, the plug-in vehicles from an external power supply attract attentions. Here, the plug-in vehicle may include an electric automobile, a hybrid automobile with an electric motor and internal combustion engine, and other vehicles having rechargeable battery as a power source to move the vehicle. One typical usage of the plug-in vehicle would be as follows: the plug-in vehicle is driven for a certain distance, then, the plug-in vehicle is parked at a station such as a garage in a residence, and the plug-in vehicle is prepared for a next drive by charging a battery from an external power source during parking.

An electric vehicle power line communication system is disclosed in the following document 1. In this conventional system, the electric vehicle is charged by using a power line network installed in a house. Further, it is disclosed to improve a security for charging the electric vehicle by using the power line network. In this conventional system, an electric vehicle and a system on a power outlet on a wall of the house are assigned with a pair of identification codes or information, respectively. Therefore, it is possible to verify whether a charging activity is approved or non-approved by verifying the identification codes. The system prohibits charging when a combination of the identification codes is not a proper pair. It is also disclosed that the system gives alarm on a device in an audiovisual fashion if a plug is removed without disarming a security key.

Patent document 1: JP2003-23378A

### SUMMARY OF THE INVENTION

However, in a system which manages a plug-in vehicle, there may be several requirements to use various kinds of hardware components for preventing power theft via the system for charging the plug-in vehicle from the station. Therefore, in order to prevent power theft by using various kinds of hardware, the conventional technology disclosed in the patent document 1 is not enough.

It is an object of the present invention to prevent power theft through a system for charging a plug-in vehicle. It is another object of the present invention to prevent power theft through a system for charging a plug-in vehicle by using a vehicle related system that has a security function for another purpose.

In a first aspect of the present invention, a management system for charging a plug-in vehicle is provided. The system comprises a communication module and a security module. The communication module retrieves identification information from a key with an electronic certification to perform locking and releasing of a door lock in the plug-in vehicle. The security module includes a verification module for verifying whether there is a proper key or not based on the identification information retrieved by the communication module. The security module permits a charging activity to the plug-in vehicle when detecting a proper key, or refuses the charging activity when detecting no proper key. The key for a door lock system has identification information which is certified and issued to the door lock system for a purpose of verifying the proper user or the proper owner of the vehicle. Therefore, the identification information in the key is one of the information which can identify the plug-in vehicle or a user. In addition, the identification information in the key is primarily issued for the door lock system. Therefore, it is possible to prevent power theft by using such identification information issued to a device or system belonging to the vehicle. The key may transmit the identification information via communication medium, such as radio wave, light, or direct wire connection. Among those, a wireless communication key is preferable.

In a second aspect of the present invention, a management system for charging a plug-in vehicle is provided. The system comprises a communication module and a security module. The communication module retrieves position information from a vehicle navigation system, the position information being capable of identifying the plug-in vehicle or a user. The security module includes a verification module for verifying whether the position information retrieved by the communication module is proper or not. The security module permits a charging activity to the plug-in vehicle when detecting proper position information, or refuses the charging activity when detecting no proper position information.

The position information such as a specific position or address of the charging station, a driven route, drive history are unique for each plug-in vehicle. Therefore, the position information may be used as identification information. Therefore, it is possible to prevent power theft by using such identification information originally created by the car-navigation system belonging to the vehicle. The position information may be transmitted via communication medium, such as radio wave, light, or direct wire connection through a pier-to-pier connection, such as a power line communication, LAN or WAN, such as the Internet.

In a third aspect of the present invention, a management system for charging a plug-in vehicle is provided. The system comprises a network communication module and a security module. The network communication module retrieves identification information capable of identifying a plug-in vehicle or a user supplied from a component belonging to the plug-in vehicle through a network communication device related to the plug-in vehicle. The security module permits a charging activity to the plug-in vehicle when the identification information retrieved by the network communication module is proper, and refuses the charging activity when no proper identification information is retrieved.

The network communication module may be provided by components for establishing a LAN communication, or a WAN communication in a wireless connection or a wire connection. The identification information may be issued for the plug-in vehicle charging system. Alternatively, the identification information may be information primarily issued for a system or device related to the plug-in vehicle. For example, the plug-in vehicle charging system may use the identification information related to a door lock system or a car-navigation system, and the identification information for establishing a network connection. According to the configuration, it is possible to prevent power theft by using identification information retrieved from the plug-in vehicle via a network connection.

### BRIEF DESCRIPTION OF THE DRAWINGS

Additional objects and advantages of the present invention will be more readily apparent from the following detailed description of preferred embodiments when taken together with the accompanying drawings. In which:

FIG. 1 is a block diagram showing a plug-in vehicle charge management system according to a first embodiment of the present invention;

FIG. 2 is a block diagram showing a plug-in vehicle charge management system according to a second embodiment of the present invention;

FIG. 3 is a block diagram showing a plug-in vehicle charge management system according to a third embodiment of the present invention;

FIG. 4 is a block diagram showing a plug-in vehicle charge management system according to a fourth embodiment of the present invention;

FIG. 5 is a block diagram showing a plug-in vehicle charge management system according to a fifth embodiment of the present invention; and

FIG. 6 is a block diagram showing a plug-in vehicle charge management system according to a sixth embodiment of the present invention.

### DETAILED DESCRIPTION OF THE PREFERRED EMBODIMENTS

A plurality of preferred embodiments of management system for charging a plug-in vehicle according to the present invention are described by referring to the attached drawings.

### First Embodiment

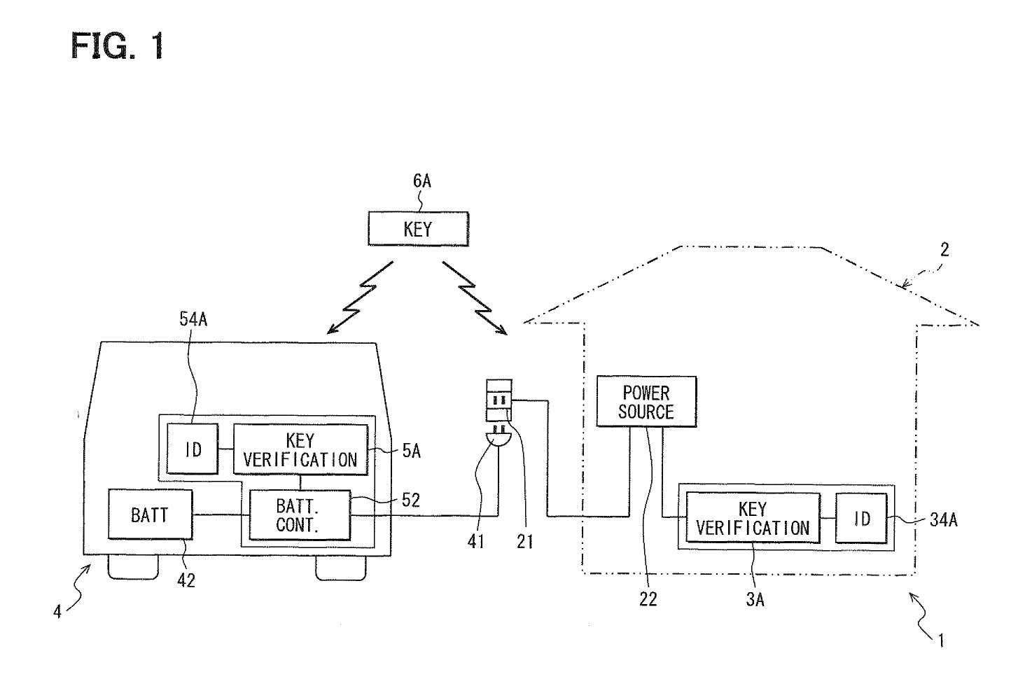

The plug-in vehicle charging management system 1 enables charging of electricity to a battery in the plug-in vehicle 4 from a power outlet of a power source 22 such as a commercial power source 22 in a charging station 2, as shown in FIG. 1. The plug-in vehicle 4 includes a remote control system in which a device mounted on the plug-in vehicle 4 can be controlled from a remote controller such as a key which stores and transmits identification information. For example, a door lock system using an electronic certification key 6A is known as the remote control system. In such a system, the electronic certification key 6A is a component belonging to the plug-in vehicle.

In detail, the plug-in vehicle 4 uses an electronic certification key 6A which performs locking and releasing a door lock device on the plug-in vehicle based on an electronic verification. Hereinafter, the electronic certification key 6A is referred to as the key 6A. The plug-in vehicle 4 includes a vehicle side connector (socket) 41, a rechargeable battery 42 which is constructed to be charged from an external power source 22 via the vehicle side connector 41, and a key verification controller 5A which determines whether the key GA is a proper one or not. The key verification controller 5A may be a part of the door lock system and controls the door lock device in response to a signal from the key GA. Therefore, the key 6A is a vehicle related system that has a security function for a door lock controlling purpose that is other than a purpose for preventing power theft.

A charging station 2 includes a power source 22, a station side connector (a power outlet) 21 which is connected with the power source and is capable of being connected to the vehicle side connector 41, and a key verification controller 3A which determines whether the key 6A is a proper one or not. The power source is an external power source and may be a commercial power source or a private power source. The key verification controllers 3A and 5A include a wireless communication device, respectively, and retrieve identification information from the key 6A. The identification information is information certified to show the key 6A is a proper one for the plug-in vehicle 4.

In the plug-in vehicle charging management system 1, the key verification controller 3A verifies whether there is a proper one of the key 6A exists or not when the vehicle side connector 41 is connected to the station side connector 21. The key verification controller 3A is further constructed to control charging to the battery 42 from the power source 22 according to the result of the verification in order to prevent power theft by not approved vehicle that does not have a proper key. The key verification controller 3A permits charging to the battery 42 from the power source 22 when existence of the proper one of the key 6A is detected. On the other hand, the key verification controller 3A refuses and prohibits charging to the battery 42 from the power source 22 when existence of the proper one of the key 6A is not detected. The key 6A alone or the key verification controller 5A and appropriate communication system from the vehicle 4 to the station 2 may provide a communication module which retrieves identification information from the key 6A. The key verification controller 3A provides a verification module for a security module.

As shown in FIG. 1, the plug-in vehicle charging management system 1 prevents power theft by using the key with an electronic certification code to perform locking and releasing of a door lock device in the plug-in vehicle 4. The electronic certification code is primarily obtained to achieve certain level of security for the door lock system in the plug-in vehicle. However, in this embodiment, the electronic certification code is used as identification information to prevent power theft too. Here, the key 6A may also be referred to as a key for a smart entry system. In addition, the plug-in vehicle 4 may include an automobile burglar prevention apparatus, i.e., an immobilizer, which permits start up of a drive motor or a hybrid engine only when the key verification controller 5A detects existence of the proper key 6A.

The plug-in vehicle 4 includes a battery controller 52 which controls charging and discharging of the battery 42. The key verification controller 5A in the plug-in vehicle 4 and the key verification controller 3A in the charging station 2 include user information storage devices 54A and 34A, respectively. The user information storage devices 54A and 34A store data for verifying the identification information retrieved from the key 6A. In a simple case, the user information storage devices 54A and 34A store the same identification information stored in the key 6A. The power source 22 in the charging station 2 may include a charge control device which may be installed on a distributor box and controls charging current supplied to the plug-in vehicle 4. FIG. 1 shows functional relations among components and modules. Therefore, connections among components and modules are not limited to the illustrated one.

In this embodiment, the charging station 2 includes the key verification controller 3A which detects whether the key 6A is proper or not. Then, when the vehicle side connector 41 in the plug-in vehicle 4 is connected to the station side connector 21 in the charging station 2, the key verification controller 3A in the charging station 2 determines whether charging to the battery 42 from the power source 22 shall be permitted or be refused by detecting whether the proper key 6A exists in a predetermined range in which the system can verify the key 6A. The key verification controller 3A in the charging station 2 refuses charging to the battery 42 from the power source 22 when existence of the proper key 6A is not detected. The key verification controller 3A permits charging to the battery 42 only when the proper user who is approved to charge a plug-in vehicle 4 at the charging station 2 connects the vehicle side connector 41 and the station side connector 21. Therefore, it is possible to prevent power theft from the station side connector 21.

As mentioned above, according to the plug-in vehicle charging management system 1 in this embodiment, it is possible to perform preventive measures against power theft at the charging station for charging the plug-in vehicle 4.

### Second Embodiment

In the following description and drawings, the same reference numbers and symbols are given to components and parts which are the same or similar to that already described in the preceding embodiments. The preceding description may be referenced for the components and parts denoted by the same reference numbers and symbols. Hereinafter, differences from the preceding embodiments are mainly explained. Other configurations are similar to or the same as that of the above-mentioned embodiments, therefore, it is possible to achieve similar or the same functions and advantages as described in the above-mentioned embodiment.

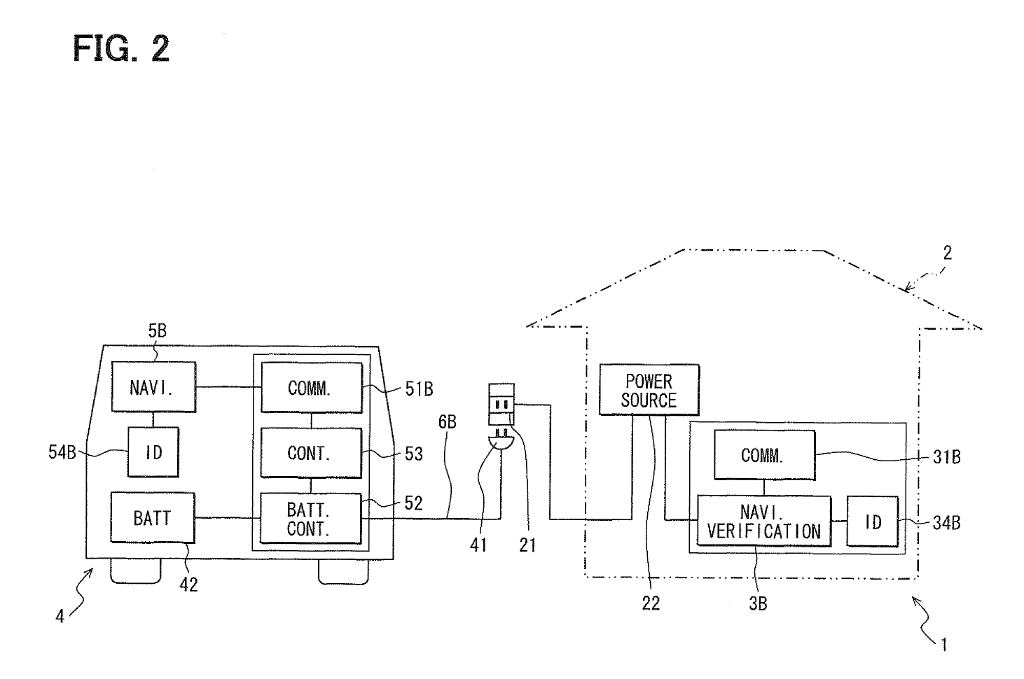

In this embodiment, the plug-in vehicle charging management system 1 prevents power theft by using a car-navigation system 5B on the plug-in vehicle 4, as shown in FIG. 2.

The plug-in vehicle charging management system 1 enables charging to the plug-in vehicle 4 from the power source 22 in the charging station, and includes a communication module which includes devices to provide a power line communication via a power line 6B which is provided by a wire connecting between the charging station 2 and the plug-in vehicle 4.

The plug-in vehicle 4 includes a vehicle side power-line-communication device 51B which performs the power line communication with the charging station 2, a car-navigation system 5B connected to the vehicle side power-line-communication device 51B, and a controller 53 connected with the vehicle side power-line-communication device 51B and the car-navigation system 5B. The car-navigation system 5B displays information such as a current position, a travel path to the destination, etc. on a display screen to show those information to a driver at the time of operation of the vehicle. In addition, the ear-navigation system 5B is constructed to input and manage various kinds of information, including user identification information, house address information, vehicle information, etc.

The charging station 2 includes a station side power-line-communication device 31B which performs the power line communication with the vehicle side power-line-communication device 51B, and a verification controller 3B which can retrieve information in the car-navigation system 5B via the station side power-line-communication device 31B.

In addition, the car-navigation system 5B in the plug-in vehicle 4 and the verification controller 3B in the charging station 2 include user information storage devices 54B and 34B, respectively. The user information storage devices 54B and 34B store data for verifying whether the plug-in vehicle 4 is approved for being charged at the charging station 2.

The plug-in vehicle charging management system 1 is constructed to enable the power line communication via both the vehicle side power-line-communication device 51B and the station side power-line-communication device 31B when the vehicle side connector 41 is connected with the station side connector 21. The plug-in vehicle charging management system 1 is constructed to perform verification by the verification controller 3B during the power line communication is possible. The verification is performed by comparing position information stored in the user information storage device 34B in the verification controller 3B and position information stored in the user information storage device 54B in the car-navigation system 5B. If it is verified that the plug-in vehicle 4 or the user is approved for charging, the verification controller 3B permits charging to the battery 42 from the power source 22. For example, if the position data stored in the user information storage device 34B and the position data stored in the user information storage device 54B are identical each other, then the verification controller 3B determines that the plug-in vehicle 4 or the user is approved for charging. On the other hand, the plug-in vehicle charging management system 1 is constructed so that the verification controller 3B refuses charging to the battery 42 from the power source 22 if it is determined that the plug-in vehicle 4 or the user is not approved for charging by comparing position information stored in the user information storage device 34B in the verification controller 3B and position information stored in the user information storage device 54B in the car-navigation system 5B.

The data stored in the user information storage devices 54B and 34B are position information which is used as identification information. The user information storage devices 54B and 34B may store data indicative of an address of the charging station, such as a home, or drive history data, such as past destinations or paths as identification information. In a case that the position information stored in the user information storage devices 54B and 34B are the drive history data, the drive history data may be position information, such as an address, of a place to which the plug-in vehicle 4 is driven repeatedly. In a typical case, the identical data is stored in the user information storage devices 54B and 34B.

The power line communication is performed by superimposing a high-frequency modulated signal with a small voltage on the power line where an alternating voltage, such as 50 Hz or 60 Hz is supplied from the power source 22. The high-frequency modulated signal is supplied and received by the station side power-line-communication device 31B and the vehicle side power-line-communication device 51B. The power line communication is performed between the station side power-line-communication device 31B and the vehicle side power-line-communication device 518 via the wiring part connecting the station side connector 21 and the vehicle side connector 41.

When the vehicle side connector 41 in the plug-in vehicle 4 is connected to the station side connector 21 in the charging station 2, the power line communication becomes possible between the vehicle side power-line-communication device 51B and the station side power-line-communication device 31B.

Then, when the above mentioned connection is provided, the verification controller 3B determines that whether the plug-in vehicle parked in the charging station 2 is approved for charging or not by comparing the position information.

In this embodiment, by performing the comparison, if it is determined that the position information stored in the user information storage devices 54B and the position information stored in the user information storage device 34B are not coincide with each other, it is determined that the user or the plug-in vehicle 4 is not proper and not approved for charging.

In a case that the user is not proper, the system refuses to charge the battery 42 from the power source 22. Therefore, the system enables charging to the battery 42 only when a proper user connects the vehicle side connector 41 and the station side connector 21.

In the second embodiment, the car-navigation system 58 provides position information which is capable of identifying the plug-in vehicle or a user. A communication module is provided by devices related to the power line communication. A security module is provided by the verification controller 3B which verifies whether the position information retrieved by the communication module is proper or not. The verification controller 3B permits a charging activity to the plug-in vehicle 4 when detecting a proper position information, or refuses the charging activity when detecting no proper position information.

### Third Embodiment

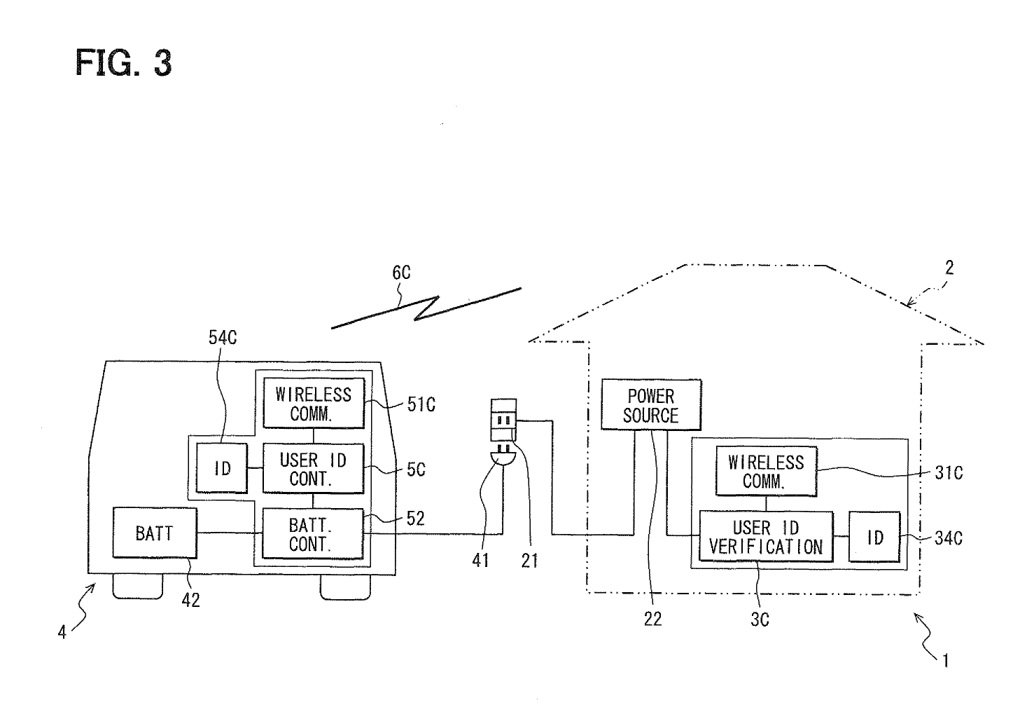

As shown in FIG. 3, a third embodiment includes wireless LAN communication devices 51C and 31C in the plug-in vehicle 4 and the charging station 2, respectively, and uses them to prevent power theft.

The plug-in vehicle 4 includes a vehicle side wireless LAN communication device 51C which performs wireless LAN communication 6C with a device in the charging station 2 and a user ID controller 5C connected with the vehicle side wireless LAN communication device 51C. The wireless LAN communication 6C is wireless communication via a Local Area Network.

The charging station 2 includes a station side wireless LAN communication device 31C which performs wireless communication with the vehicle side wireless LAN communication device 51C and a user ID verification controller 3C which can retrieve the information from the user ID controller 5C via the station side wireless LAN communication device 31C and verifies whether the retrieved information is proper or not.

The plug-in vehicle charging management system 1 is constructed to perform verification by the verification controller 3C when the station side connector 21 and the vehicle side connector 41 are connected. The verification is performed by comparing user information stored in the user information storage device 34C in the verification controller 3C and user information stored in the user information storage device 54C in the user ID controller 5C. If it is verified that the plug-in vehicle 4 or the user is approved for charging, the verification controller 3C permits charging to the battery 42 from the power source 22. For example, if the user information stored in the user information storage device 34C and the user information stored in the user information storage device 54C are identical each other, then the verification controller 3C determines that the plug-in vehicle 4 or the user is approved for charging. On the other hand, the plug-in vehicle charging management system 1 is constructed so that the verification controller 3C refuses charging to the battery 42 from the power source 22 if it is determined that the plug-in vehicle 4 or the user is not approved for charging by comparing the user information stored in the user information storage device 34C in the verification controller 3C and the user information stored in the user information storage device 54C in the user ID controller 5C.

In this embodiment, when the plug-in vehicle 4 and the charging station 2 are located nearby, i.e., within a range of a predetermined distance where communication is possible, the vehicle side wireless LAN communication device 51C and the station side wireless LAN communication device 31C can communicate with each other via wireless LAN communication. The verification controller 3C is constructed so as to perform verification of the proper user before the vehicle side connector 41 and the station side connector 21 are connected. That is, the verification controller 3C performs verification when the vehicle side wireless LAN communication device 51C and the station side wireless LAN communication device 31C are located within a communication range. For example, the verification controller 3C is constructed to perform verification for the plug-in vehicle 4 which runs near the charging station 2 or the plug-in vehicle 4 which is parked on the charging station 2. Thereby, it is possible to perform the verification before the plug-in vehicle 4 is parked on the charging station 2, therefore, it is possible to determine whether charging is permissible or not at an early stage.

On the other hand, the verification controller 3C may be constructed to perform the verification when a connection between the vehicle side connector 41 and the station side connector 21 is provided or after the connection is provided. In detail, the vehicle side wireless LAN communication device 51C and the station side wireless LAN communication device 31C initiate communication via the wireless LAN when a connection between the vehicle side connector 41 and the station side connector 21 is provided or after the connection is provided. Then, the verification controller 3C performs the verification about the plug-in vehicle 4 parked on the charging station 2. In this case, it is possible to shorten communication time in which the wireless LAN communication 6C is performed, therefore, it is possible to perform the verification in a power saving manner.

Then, when the above mentioned connection is provided, the verification controller 3C determines that whether the plug-in vehicle 4 parked in the charging station 2 is approved for charging or not by comparing the user information.

In this embodiment, by performing the comparison, if it is determined that the user information stored in the user information storage devices 54C and the user information stored in the user information storage device 34C are not coincide with each other, it is determined that the user or the plug-in vehicle 4 is not proper and not approved for charging.

In a case that the user is not proper, the system refuses to charge the battery 42 from the power source 22. Therefore, the system enables charging to the battery 42 only when a proper user connects the vehicle side connector 41 and the station side connector 21.

In the third embodiment, components 5C, 51C, 6C, and 31C for establishing the wireless LAN connection provide the network communication module. The verification controller 3C provides the security module.

### Fourth Embodiment

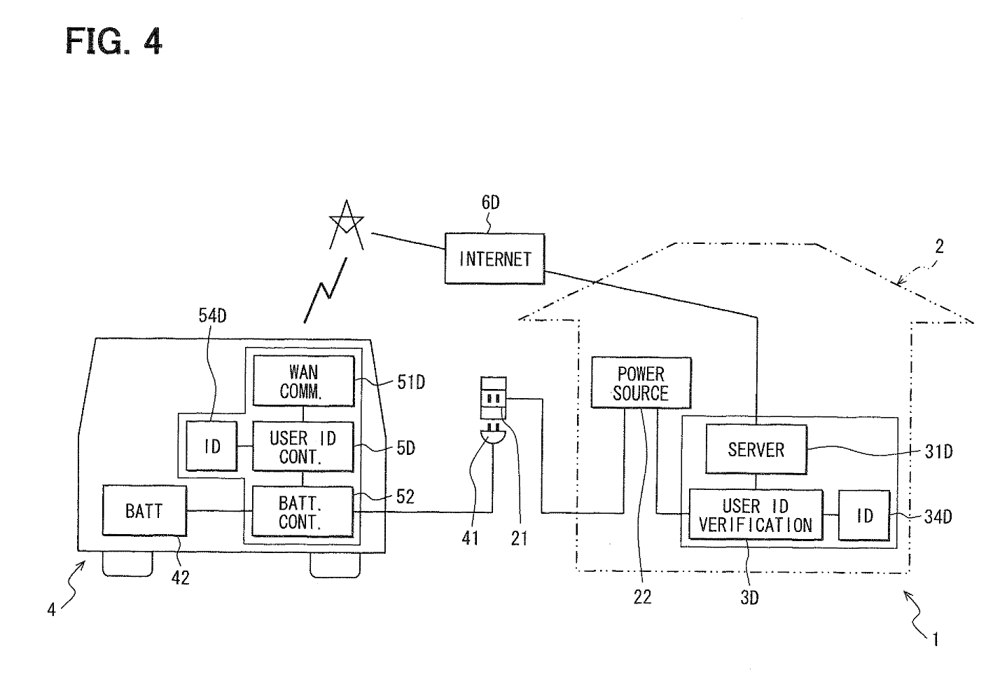

As shown in FIG. 4, in this embodiment, the plug-in vehicle 4 and the charging station 2 are configured to be connectable to the Internet via a WAN communication device 51D and a server computer 31D, respectively, and to prevent power theft by retrieving identification information via the Internet.

The plug-in vehicle 4 includes a WAN communication device connectable to a Wide Area Network such as the Internet 6D, and a user ID controller 5D connected with the WAN communication device 51D. The WAN communication device 51D performs communication via the Wide Area Network. The WAN communication device 51D may be a wireless communication device. The charging station 2 includes a server computer 31D which is connectable to the Internet 6D and a verification controller 3D which can retrieve the user information from the user ID controller 5D via the Internet 6D and the server computer 31D and verifies whether the retrieved user information is proper or not. In other words, the verification controller 3D determines that whether the user information is proper or not.

The plug-in vehicle charging management system 1 is constructed to perform verification by the verification controller 3D when the station side connector 21 and the vehicle side connector 41 are connected. The verification is performed by comparing user information stored in the user information storage device 34D in the verification controller 3D or the server computer 31D and user information stored in the user information storage device 54D in the user ID controller 5D. If it is verified that the plug-in vehicle 4 or the user is approved for charging, the verification controller 3D permits charging to the battery 42 from the power source 22. On the other hand, the plug-in vehicle charging management system 1 is constructed so that the verification controller 3D refuses charging to the battery 42 from the power source 22 if it is determined that the plug-in vehicle 4 or the user is not approved for charging by comparing the user information stored in the user information storage device 340 and the user information stored in the user information storage device 54D. The user information storage device 34D may be provided or and connected with either the verification controller 3D or the server computer 31D.

The verification controller 3D is constructed so as to perform verification of the proper user before the vehicle side connector 41 and the station side connector 21 are connected. That is, the WAN communication device 510 and the server computer 31D are connected to the Internet 6D when the plug-in vehicle 4 comes into a range of a predetermined distance from the charging station 2. Then, the verification controller 3C performs verification whether the user of the plug-in vehicle 4 which runs near the charging station 2 or is parked on the charging station 2 is proper and approved for charging when the plug-in vehicle 4 comes into the predetermined distance range from the charging station 2. Thereby, it is possible to perform the verification before the plug-in vehicle 4 is parked on the charging station 2, therefore, it is possible to determine whether charging is permissible or not at an early stage.

On the other hand, the verification controller 3D may be constructed to perform the verification when a connection between the vehicle side connector 41 and the station side connector 21 is provided or after the connection is provided. In detail, the WAN communication device 51D and the server computer 31D establish connections to the Internet 6D when a connection between the vehicle side connector 41 and the station side connector 21 is provided or after the connection is provided. Then, the verification controller 3D performs the verification about the plug-in vehicle 4 parked on the charging station 2. In this case, it is possible to shorten a connection time to the Internet 6D, therefore, it is possible to perform the verification in a power saving manner.

In this embodiment, the user information stored in the user information storage device 54D is transmitted by the WAN communication device 51D to the server computer 31D through the Internet 6D, and is further transmitted to the verification controller 3D. Then, the verification controller 3D determines that whether the plug-in vehicle 4 owned by the proper user is parked on the charging station 2 or not. The verification controller 3D verifies the user information based on the user information stored in the user information storage devices 54D and 34D. For example, the verification controller 3D determines whether the user information in the user information storage devices 54D and 34D coincide with each other or not.

In this embodiment, by performing the comparison, if it is determined that the user information stored in the user information storage device 54D and the user information stored in the user information storage device 34D are not coincide with each other, it is determined that the user or the plug-in vehicle 4 is not proper and not approved for charging.

In a case that the user is not proper, the system refuses to charge the battery 42 from the power source 22. Therefore, the system enables charging to the battery 42 only when a proper user connects the vehicle side connector 41 and the station side connector 21.

In the fourth embodiment, components 5D, 51D, 6D, and 31D for establishing the WAN connection provide the network communication module. The verification controller 3D provides the security module.

### Fifth Embodiment

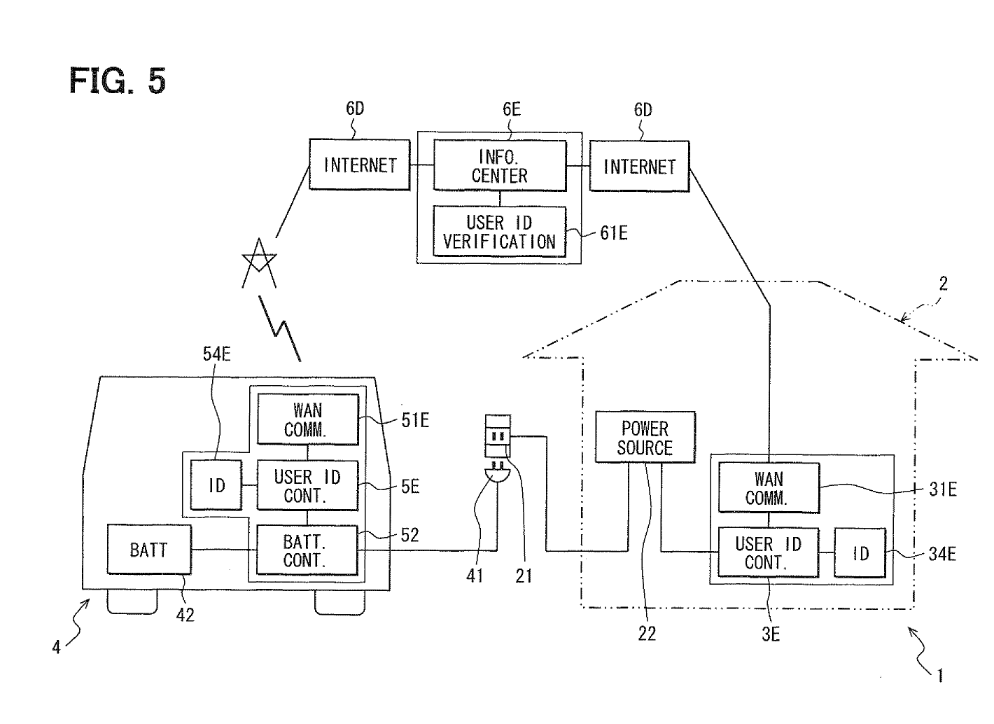

As shown in FIG. 5, in this embodiment, the system prevents power theft by using an information center 6E which can communicate with both the plug-in vehicle 4 and the charging station 2 via the Internet 6D. The information center may be a traffic control information center which monitors and/or manages vehicles on traffics. For example, the information center collects probe information from vehicles and provides traffic information to the vehicles.

The plug-in vehicle 4 includes a WAN communication device 51E connectable with the Internet 6D and a user ID controller 5E connected with the WAN communication device 51E. The user ID controller 5E includes a user information storage device 54E storing user information. The charging station 2 includes a WAN communication device 31E which is connectable to the Internet 6D and a user ID controller 3E which is connected with the WAN communication device 31E. The WAN communication device 31E may be referred to as an internet communication device. The user ID controller 3E includes a user information storage device 34E storing user information. In addition, the plug-in vehicle 4 is monitored and managed by the information center 6E based on the probe information. Here, probe information is indicative of a location, speed, etc., and is collected from the plug-in vehicle 4 on traffic in a real time manner.

The information center 6E includes a verification controller 61E which verifies the user information retrieved from the plug-in vehicle 4 and the charging station 2 via the Internet 6D. For example, the verification controller 61E determines that whether both user information retrieved from the plug-in vehicle 4 and the charging station 2 coincide with each other or not.

In this embodiment, the user information stored in the user information storage device 54E is transmitted by the WAN communication device 51E to the information center 6E through the Internet 6D when the vehicle side connector 41 and the station side connector 21 are connected. Simultaneously, the WAN communication device 31E transmits the user Information stored in the user information storage device 34E to the information center 6E through the Internet 6D. Then, the verification controller 61E determines that whether the plug-in vehicle 4 owned by the proper user is parked on the charging station 2 or not. The verification controller 61E verifies the user information based on the user information stored in the user information storage devices 54E and 34E. For example, the verification controller 61E determines whether the user information in the user information storage devices 54E and 34E coincide with each other or not. If it is determined that the user is proper, the information center 6E transmits a command to the charging center to permit charging to the battery 42 from the power source 22. On the other hand, if it is determined that the user is not proper, the information center 6E transmits a command to the charging center to refuse charging.

In this embodiment, by performing the comparison, if it is determined that the user information stored in the user information storage device 54E and the user information stored in the user information storage device 34E are not coincide with each other, it is determined that the user or the plug-in vehicle 4 is not proper and not approved for charging.

In a case that the user is not proper, the system refuses to charge the battery 42 from the power source 22 in response to a command from the information center 6E. Therefore, the system enables charging to the battery 42 only when a proper user connects the vehicle side connector 41 and the station side connector 21.

In the fifth embodiment, components 3E, 5E, 51E, 6D, 6E and 31E for establishing the WAN connection provide the network communication module. The verification controller 61E provides the security module.

### Sixth Embodiment

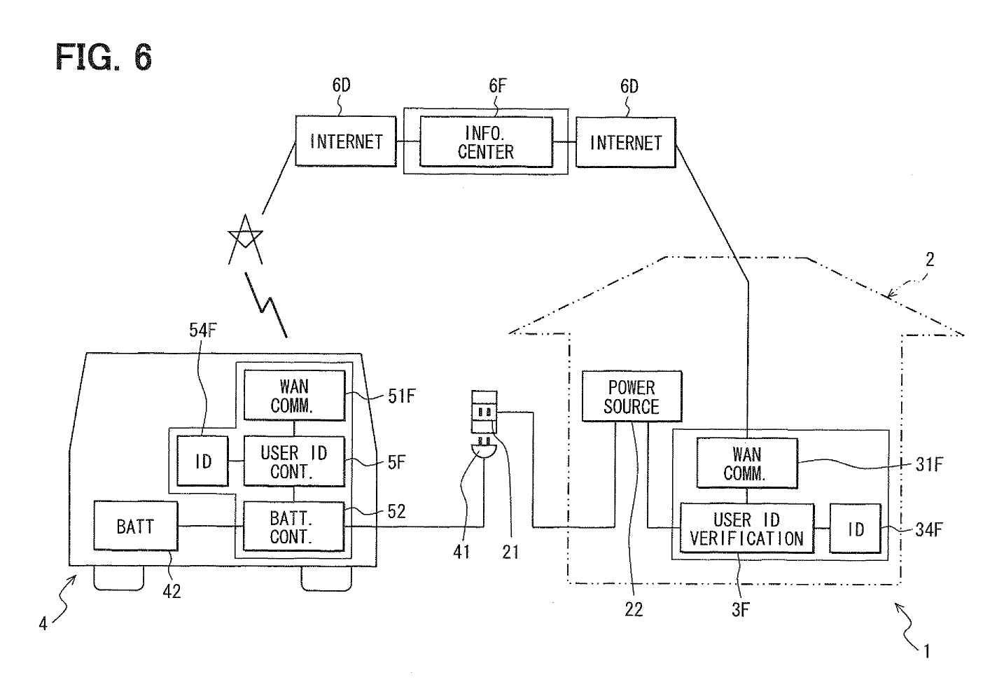

As shown in FIG. 6, in this embodiment, the system prevents power theft by using an information center 6F which can communicate with both the plug-in vehicle 4 and the charging station 2 via the Internet 6D.

The plug-in vehicle 4 includes a WAN communication device 51F connectable with the Internet 6D and a user ID controller 5F connected with the WAN communication device 51F. The user ID controller 5F includes a user information storage device 54F storing user information. The charging station 2 includes a WAN communication device 31F which is connectable to the Internet 6D and a verification controller 3F which is connected with the WAN communication device 31F. The verification controller 3F includes a user information storage device 34F storing user information. The plug-in vehicle 4 is monitored and managed by the information center 6F based on the probe information.

In this embodiment, the user information stored in the user information storage device 54F is transmitted by the WAN communication device 51F to the information center 6F through the Internet 6D when the vehicle side connector 41 and the station side connector 21 are connected. The information center 6F relays the user information to the charging station 2. Then, the verification controller 3F retrieves the user information stored in the user information storage device 54F through the information center 6F, the WAN communication device 31F and the Internet 6D. Then, the verification controller 3F determines that whether the plug-in vehicle 4 owned by the proper user is parked on the charging station 2 or not. The verification controller 3F verifies the user information based on the user information stored in the user information storage devices 54F and 34F. For example, the verification controller 3F determines whether the user information in the user information storage devices 54F and 34F coincide with each other or not. If it is determined that the user is proper, the verification controller 3F permits charging to the battery 42 from the power source 22. On the other hand, if it is determined that the user is not proper, the verification controller 3F refuses charging.

In this embodiment, by performing the comparison, if it is determined that the user information stored in the user information storage device 54F and the user information stored in the user information storage device 34F are not coincide with each other, it is determined that the user or the plug-in vehicle 4 is not proper and not approved for charging. In a case that the user is not proper, the verification controller 3F refuses to charge the battery 42 from the power source 22. Therefore, the system enables charging to the battery 42 only when a proper user connects the vehicle side connector 41 and the station side connector 21.

In the sixth embodiment, components 5F, 51F, 6D, 6F and 31F for establishing the WAN connection provide the network communication module. The verification controller 3F provides the security module.

### Other Embodiments

The above embodiments may further includes a device which sends a message or make a phone call to a terminal device such as a mobile phone for the proper user or the owner of the charging station if the verification controller refuses charging. Although some of the preceding embodiments use the user information for identifying purpose, alternatively, the user information may be replaced with information which can identify the plug-in vehicle 4. For example, certification information issued to the remote key system or position information originally created by a car-navigation system on the plug-in vehicle 4 may be used as alternatives for the user information. The components and modules in the above embodiments may be provided by software, hardware or combination of them.

Although the present invention has been fully described in connection with the preferred embodiments thereof with reference to the accompanying drawings, it is to be noted that various changes and modifications will become apparent to those skilled in the art. Such changes and modifications are to be understood as being within the scope of the present invention as defined by the appended claims.

What is claimed is:

1. A management system for charging a plug-in vehicle, comprising:
a communication module which retrieves identification information from a key with an electronic certification to perform locking and releasing of a door lock in the plug-in vehicle; and
a security module which includes a verification module for verifying whether there is a proper key or not based on the identification information retrieved by the communication module, and which permits a charging activity to the plug-in vehicle when detecting a proper key, or refuses the charging activity when detecting no proper key.

2. A management system for charging a plug-in vehicle, comprising:
a communication module which retrieves position information from a vehicle navigation system, the position information being capable of identifying the plug-in vehicle or a user; and
a security module which includes a verification module for verifying whether the position information retrieved by the communication module is proper or not, and which permits a charging activity to the plug-in vehicle when detecting a proper position information, or refuses the charging activity when detecting no proper position information.

3. A management system for charging a plug-in vehicle, comprising:
a network communication module which retrieves identification information capable of identifying a plug-in vehicle or a user supplied from a component belonging to the plug-in vehicle through a network communication device related to the plug-in vehicle; and
a security module which permits a charging activity to the plug-in vehicle when the identification information retrieved by the network communication module is proper, and refuses the charging activity when no proper identification information is retrieved.

4. The management system for charging a plug-in vehicle claimed in claim 3, wherein
the network communication module includes:
a vehicle side wireless LAN communication device which transmits the identification information supplied from an identification information storage device belonging to the plug-in vehicle to a wireless LAN; and
a station side wireless LAN communication device located on a charging station, which performs wireless communication with the vehicle side wireless LAN communication device, and wherein
the security module is located on the charging station, and includes a verification controller which retrieves the identification information via the station side wireless LAN communication device, and which permits a charging activity to the plug-in vehicle when the identification information is proper, and refuses the charging activity when no proper identification information is retrieved.

5. The management system for charging a plug-in vehicle claimed in claim 4, wherein
the verification controller performs a verification of the identification information in response to an event in which the vehicle side wireless LAN communication device and the station side wireless LAN communication device are placed within a wireless communication range, even before a connector on the charging station and a connector on the plug-in vehicle are connected.

6. The management system for charging a plug-in vehicle claimed in claim 4, wherein
the vehicle side wireless LAN communication device and the station side wireless LAN communication device initiate communication via the wireless LAN when a connection between a connector on the charging station and a connector on the plug-in vehicle is provided or after the connection is provided, and then, the verification controller performs a verification of the identification information.

7. The management system for charging a plug-in vehicle claimed in claim 3, wherein
the network communication module includes:
a WAN communication device which transmits the identification information supplied from an identification information storage device belonging to the plug-in vehicle to the Internet; and
a server computer located on a charging station, which is connectable with the Internet, and wherein
the security module includes:
a verification controller located on the charging station, which retrieves the identification information via the server computer, and which permits a charging activity to the plug-in vehicle when the identification information is proper, and refuses the charging activity when no proper identification information is retrieved.

8. The management system for charging a plug-in vehicle claimed in claim 7, wherein
the verification controller performs a verification of the identification information in response to an event in which the plug-in vehicle is located within a predetermined distance from the charging station, even before a connector on the charging station and a connector on the plug-in vehicle are connected.

9. The management system for charging a plug-in vehicle claimed in claim 7, wherein
the WAN communication device and the server computer connect to the Internet when a connection between a connector on the charging station and a connector on the plug-in vehicle is provided or after the connection is provided, and then, the verification controller performs a verification of the identification information.

10. The management system for charging a plug-in vehicle claimed in claim 3, wherein
the network communication module includes:
a WAN communication device which transmits the identification information supplied from a vehicle side identification information storage device belonging to the plug-in vehicle to the Internet; and
an internet communication device located on a charging station, which is connectable with the Internet and is capable of transmitting identification information supplied from a station side identification information storage device belonging to the charging station to the Internet, and wherein
the security module includes:
a verification controller located on an information center connected with the Internet, which retrieves the identification information from the vehicle side identification information storage device and the identification information from the station side identification information storage device, and which permits a charging activity to the plug-in vehicle when the identification information are proper, and refuses the charging activity when no proper identification information is retrieved.

11. The management system for charging a plug-in vehicle claimed in claim 3, wherein
the network communication module includes:
a WAN communication device which transmits the identification information supplied from an identification information storage device belonging to the plug-in vehicle to the Internet;
an internet communication device located on a charging station, which is connectable with the Internet; and an information center connected to the Internet, and wherein
the security module includes:
a verification controller located on the charging station, which is connected to the internet communication device, and retrieves the identification information from the vehicle side identification information storage device via the information center, and which permits a charging activity to the plug-in vehicle when the identification information is proper, and refuses the charging activity when no proper identification information is retrieved.
